(19) United States
(12) Patent Application Publication
(10) Pub. No.: US 2022/0204657 A1
(43) Pub. Date: Jun. 30, 2022

(54) DESULFURIZED RUBBER, RUBBER COMPOSITION CONTAINING DESULFURIZED RUBBER, AND PNEUMATIC TIRE INCLUDING RUBBER PORTION OBTAINED BY VULCANIZING AND MOLDING RUBBER COMPOSITION

(71) Applicant: Toyo Tire Corporation, Itami-shi (JP)

(72) Inventor: Shouhei Morimoto, Itami-shi (JP)

(73) Assignee: Toyo Tire Corporation, Itami-shi (JP)

(21) Appl. No.: 17/542,744

(22) Filed: Dec. 6, 2021

(30) Foreign Application Priority Data
Dec. 24, 2020 (JP) 2020-214572

(51) Int. Cl. C08C 19/30; C08K 5/43; B60C 1/00; C08K 5/375

(52) U.S. Cl. CPC C08C 19/30; C08K 5/375; B60C 1/00; C08K 5/43

(57) ABSTRACT

A desulfurized rubber obtained by mixing a desulfurization agent and a vulcanized rubber, the desulfurization agent containing a compound represented by any one of the following formulae (1) to (4):

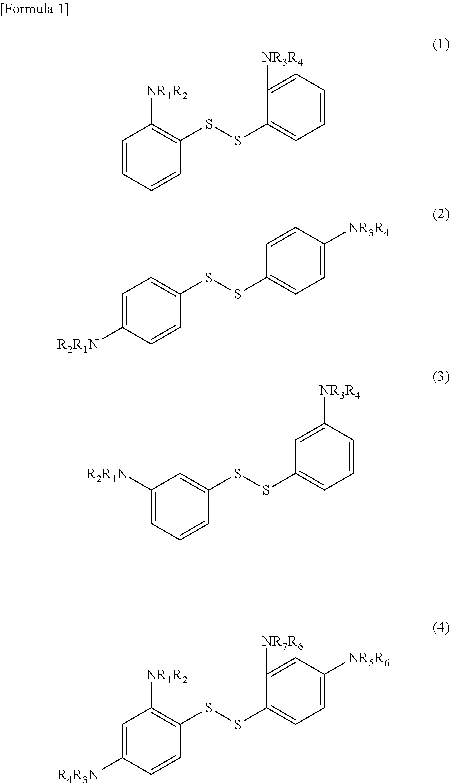

wherein R₁ to R₈ each independently represent a hydrogen atom, an oxygen atom, or an alkyl group. It is preferable that the desulfurization agent contains at least one selected from the group consisting of 2,2′-dithiodianiline and 4,4′-dithiodianiline.

### BACKGROUND OF THE INVENTION

### Field of the Invention

The present invention relates to a desulfurized rubber exhibiting good post-vulcanization physical properties and processability, a rubber composition containing the desulfurized rubber, and a pneumatic tire including a rubber portion obtained by vulcanizing and molding the rubber composition.

### Description of the Related Art

In recent years, there has been a strong demand for the reuse of vulcanized rubber waste materials generated from used tires and other rubber products due to an increase in environmental awareness.

Patent Document 1 below describes a desulfurization agent for a vulcanized rubber containing a halogenated diphenyl disulfide compound.

Patent Document 2 below describes a desulfurization agent containing a disulfide compound and a trivalent phosphorus compound.

### Prior Art Document

Patent Document

Patent Document 1: JP-A-11-323004

Patent Document 2: JP-A-08-337603

### SUMMARY OF THE INVENTION

The present inventors have zealously considered and found that the main purpose of the conventional technique is to improve the odor of a desulfurized rubber, and the conventional technique still has a room for further improvement in the post-vulcanization physical properties of a rubber composition containing the desulfurized rubber.

The present invention has been accomplished by considering the circumstances as described above, and its purpose is to provide a desulfurized rubber exhibiting good post-vulcanization physical properties, a rubber composition containing the desulfurized rubber and having excellent processability, and a pneumatic tire including a rubber portion obtained by vulcanizing and molding the rubber composition.

The above problem can be solved by the following configuration. That is, the present invention relates to a desulfurized rubber obtained by mixing a desulfurization agent and a vulcanized rubber, the desulfurization agent containing a compound represented by any one of the following formulae (1) to (4):

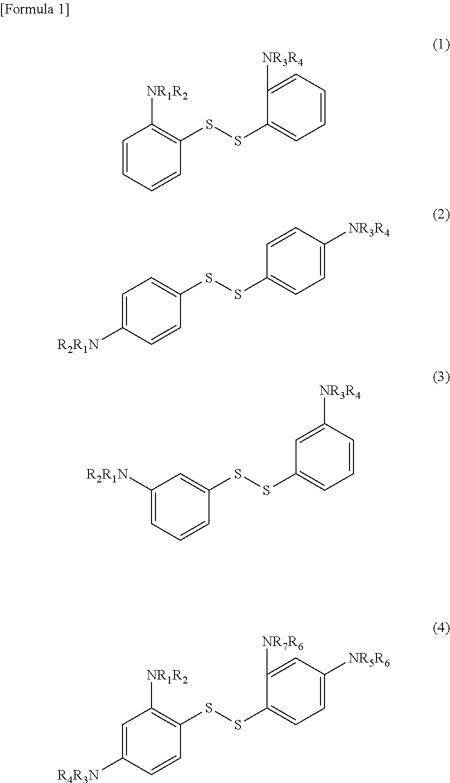

wherein R₁ to R₈ each independently represent a hydrogen atom, an oxygen atom, or an alkyl group.

In the desulfurized rubber, the desulfurization agent preferably contains at least one selected from the group consisting of 2,2′-dithiodianiline and 4,4′-dithiodianiline.

The present invention relates to a rubber composition containing the desulfurized rubber, and the rubber composition preferably contains 1 to 30 parts by mass of the desulfurized rubber based on 100 parts by mass of a total amount of an unvulcanized rubber component in the rubber composition.

Furthermore, the present invention relates to a pneumatic tire including a rubber portion obtained by vulcanizing and molding the rubber composition described above.

The conventional desulfurization agent tends to cleave not only the sulfur cross-linked portion of the vulcanized rubber but also the main chain of a rubber molecule, and therefore when the vulcanized rubber after a desulfurization treatment is re-vulcanized, post-vulcanization physical properties such as tensile strength tend to deteriorate.

Since the desulfurized rubber according to the present invention is obtained by mixing a sulfide compound having an amino group as a desulfurization agent and the vulcanized rubber, the desulfurized rubber exhibits good post-vulcanization physical properties. Good vulcanizability is considered to be provided as follows. The amino group of the desulfurization agent nucleophilically promotes the cleavage reaction of the sulfur cross-linked portion in the vulcanized rubber, thereby suppressing the cleavage of the main chain of the rubber molecule while selectively promoting the cleavage of the sulfur cross-linked portion. As the cleavage of the sulfur cross-linked portion of the vulcanized rubber is selectively promoted, the Mooney viscosities of the desulfurized rubber and the rubber composition containing the desulfurized rubber decrease, thereby providing improved processability.

### DETAILED DESCRIPTION OF THE PREFERRED EMBODIMENTS

A desulfurized rubber according to the present invention is obtained by mixing a desulfurization agent and a vulcanized rubber, the desulfurization agent containing a compound represented by any one of the following formulae (1) to (4):

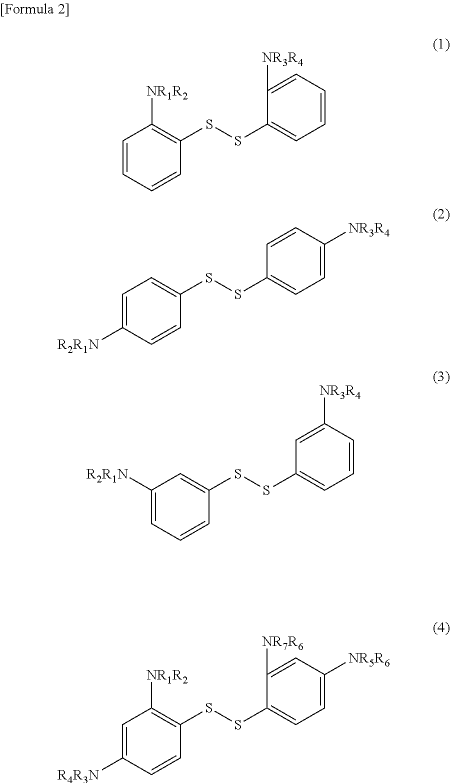

wherein R₁ to R₈ each independently represent a hydrogen atom, an oxygen atom, or an alkyl group. The desulfurization agent may contain each of the compounds represented by the formulae (1) to (4) alone, or may contain a plurality of compounds among the compounds represented by the formulae (1) to (4).

As the compounds represented by the above formulae (1) to (4) , dithioaniline in which x is 2 is suitable. Particularly suitable examples thereof include 2,2′-dithiodianiline having an amino group at an ortho position with respect to a sulfide bond in each of both phenyl groups, and 4,4′-dithiodianiline having an amino group at a para position with respect to a sulfide bond in each of both phenyl groups.

The desulfurization agent used in the present invention may contain a compound other than the compounds represented by the above formulae (1) to (4), but the content of the compound represented by the above formula (1) in the desulfurization agent is preferably 80% by mass or more, more preferably 90% by mass or more, and particularly preferably 100% by mass in order to obtain a desulfurized rubber exhibiting good post-vulcanization physical properties and processability and to suppress the odor of the obtained desulfurized rubber.

The vulcanized rubber to be a raw material of the desulfurized rubber is obtained by vulcanizing a rubber component, and a vulcanized rubber waste material generated from used tires and other rubber products can be suitably used. Examples of the rubber component to be a raw material of the vulcanized rubber include a natural rubber, and synthetic rubbers including a polyisoprene rubber, an olefin-based rubber such as an ethylene propylene rubber (EPM), a halogenated butyl rubber such as a brominated butyl rubber (Br-IIR), and others such as a polyurethane rubber, an acrylic rubber, a fluorine rubber, a silicon rubber, and chlorosulfonated polyethylene.

Sulfur to be a raw material of the vulcanized rubber may be any ordinary sulfur for rubbers. Usable examples thereof include powdery sulfur, precipitated sulfur, insoluble sulfur, and highly dispersible sulfur.

Usable examples of the vulcanized rubber to be a raw material of the desulfurized rubber include a vulcanized rubber obtained by vulcanizing a rubber composition obtained by appropriately blending, together with a rubber component and sulfur, a blending agent usually used in the rubber industry, such as a vulcanization accelerator, carbon black, silica, a silane coupling agent, zinc oxide, stearic acid, a vulcanization retardant, an organic peroxide, an antiaging agent, a softener such as wax or oil, or a processing aid, as necessary.

As the carbon black, carbon black known to those skilled in the art can be used, and for example, SAF, ISAF, HAF, FEF, and GPF and the like are used. The content of the carbon black is preferably 30 to 100 parts by mass, and more preferably 30 to 60 parts by mass based on 100 parts by mass of the total amount of the rubber component in the vulcanized rubber to be a raw material of the desulfurized rubber.

Examples of the vulcanization accelerator include vulcanization accelerators such as sulfenamide-based, thiram-based, thiazole-based, thiourea-based, guanidine-based, and dithiocarbamate-based vulcanization accelerators, which are usually used for rubber vulcanization, and these may be used alone or in appropriate combination thereof.

Examples of the antiaging agent include antiaging agents such as aromatic amine based, amine-ketone based, monophenol based, bisphenol based, polyphenol based, dithiocarbamic acid salt based, and thiourea based antiaging agents, which are usually used for rubber, and these may be used alone or in appropriate combination thereof.

Regarding the blending ratio of the desulfurization agent to be a raw material of the desulfurized rubber and the vulcanized rubber, the blending amount of the desulfurization agent is preferably 0.5 to 20 parts by mass, and more preferably 1 to 10 parts by mass, based on 100 parts by mass of the total amount of the rubber component in the vulcanized rubber.

The desulfurized rubber according to the present invention is obtained by mixing the desulfurization agent and the vulcanized rubber. The method for mixing the desulfurization agent and the vulcanized rubber is not particularly limited, and examples thereof include a method in which the desulfurization agent and the vulcanized rubber are passed through a roll known to those skilled in the art so that the desulfurization agent can cleave a sulfur cross-linked portion of the vulcanized rubber while the desulfurization agent and the vulcanized rubber are mixed. At that time, the roll may be appropriately cooled or heated.

In the obtained desulfurized rubber, the sulfur cross-linked portion of the vulcanized rubber to be reused is selectively cleaved, so that good post-vulcanization physical properties can be obtained even when the desulfurized rubber is mixed with an unvulcanized (unused) rubber component and used. The rubber composition preferably contains 1 to 30 parts by mass of the desulfurized rubber based on 100 parts by mass of the total amount of the unvulcanized rubber component in the rubber composition. As the rubber component, sulfur, a vulcanization accelerator, carbon black, silica, a silane coupling agent, zinc oxide, stearic acid, a vulcanization retardant, an organic peroxide, an antiaging agent, a softener such as wax or oil, and a processing aid and the like, which can constitute the rubber composition in which the desulfurized rubber is blended, the same as the above can be used.

A method in which the desulfurized rubber and the above components are blended is not particularly limited, and may be any of a method in which blending components other than vulcanization-based components such as sulfur and a vulcanization accelerator are kneaded in advance to form a master batch, and the remaining components are added thereto, followed by further kneading, a method in which components are added in an arbitrary order and kneaded, and a method in which all components are simultaneously added and kneaded, and the like.

The rubber composition containing the desulfurized rubber has excellent processability and post-vulcanization physical properties. Therefore, the desulfurized rubber and the rubber composition containing the desulfurized rubber according to the present invention can be particularly suitably used for the application of a pneumatic tire having a large amount of rubber portion.

### EXAMPLES

Hereinafter, Examples of the present invention will be more specifically described.

### (Preparation of Vulcanized Rubber to be Raw Material for Desulfurized Rubber)

Other blending agents except sulfur and a vulcanization accelerator were added to and kneaded with 100 parts by mass of a rubber component in a first mixing stage using a lab mixer manufactured by DAIHAN CO., LTD. according to a blending formulation in Table 1. Then, sulfur and a vulcanization accelerator were added to and kneaded with the obtained kneaded product in a second mixing stage to prepare a rubber composition.

TABLE 1
Blending vulcanized rubber (parts by mass)

| | |
|---|---|
| Natural rubber | 100 |
| Carbon black | 50 |
| Zinc flower | 2 |
| Antiaging agent | 0.5 |
| Stearic acid | 2 |
| Sulfur | 2.5 |
| Vulcanization | 1 |
| accelerator | |

The details of the respective components in Table 1 are as follows.
Natural rubber: STR 20
Carbon black: “SEAST 3” manufactured by Tokai Carbon Co., Ltd.
Zinc flower: “Zinc flower #1” manufactured by Mitsui Mining & Smelting Corporation
Antiaging agent: “NOCRAC 6C” manufactured by Ouchi Shinko Chemical Industrial Co., Ltd.
Stearic acid: “RUNACK S-20” manufactured by Kao Corporation
Sulfur: “Powdered sulfur for rubber, 150 mesh” manufactured by Hosoi Chemical Industry Co., Ltd.
Vulcanization accelerator: “NOCCELER NS” manufactured by Ouchi Shinko Chemical Industrial Co., Ltd.

The rubber composition was vulcanized at 150° C. for 25 minutes to produce a sheet-shaped vulcanized rubber, and the vulcanized rubber was pulverized using a roll (6-inch roll manufactured by Kansai Roll Co., Ltd.) to prepare a powdery vulcanized rubber (vulcanized rubber powder).
(Production of Desulfurized Rubber)

The vulcanized rubber powder and each of the desulfurization agents were mixed at a ratio shown in Table 2, and the mixture of the vulcanized rubber powder and the desulfurization agent was then caused to repeatedly pass through a roll (6-inch roll manufactured by Kansai Roll Co., Ltd.) with a roll surface cooled to 25° C., at minimum intervals of 40 minutes while the mixture was cooled, thereby producing desulfurized rubbers according to Example 1 to 4 and Comparative Example 2. In Comparative Example 1, a non-desulfurized rubber was produced for comparison.

TABLE 2

| | Blending (parts by mass) | | | | | |
|---|---|---|---|---|---|---|
| | Comparative | | | Comparative | | |
| | Example 1 | Example 1 | Example 2 | Example 2 | Example 3 | Example 4 |
| Vulcanized rubber | 100 | 100 | 100 | 100 | 100 | 100 |
| powder | | | | | | |
| Desulfurization | | 6 | | | 1 | 10 |
| agent 1 | | | | | | |
| Desulfurization | | | 6 | | | |
| agent 2 | | | | | | |
| Desulfurization | | | | 6 | | |
| agent 3 | | | | | | |

The details of the respective desulfurization agents in Table 2 are as follows.
Desulfurization agent 1 (compound represented by formula (1)): “2,2′-dithiodianiline” manufactured by Tokyo Chemical Industry Co., Ltd.
Desulfurization agent 2 (compound represented by formula (1)): “4,4′-dithiodianiline” manufactured by Tokyo Chemical Industry Co., Ltd.
Desulfurization agent 3: “Diphenyl disulfide” manufactured by Tokyo Chemical Industry Co., Ltd.

### (Preparation of Rubber Composition)

Respective components were blended with 100 parts by mass of a rubber component according to a blending formulation in Table 3, and kneaded using a lab mixer manufactured by DAIHAN CO., LTD. to prepare rubber compositions of Example 5 to 8 and Comparative Example 3 to 5.

The details of the respective components in Table 3 are as follows.
Natural rubber: STR 20
Carbon black: “SEAST 3” manufactured by Tokai Carbon Co., Ltd.
Zinc flower: “Zinc flower #1” manufactured by Mitsui Mining & Smelting Corporation
Antiaging agent: “NOCRAC 6C” manufactured by Ouchi Shinko Chemical Industrial Co., Ltd.
Stearic acid: “RUNACK S-20” manufactured by Kao Corporation
Sulfur: “Powdered sulfur for rubber, 150 mesh” manufactured by Hosoi Chemical Industry Co., Ltd.
Vulcanization accelerator: “NOCCELER NS” manufactured by Ouchi Shinko Chemical Industrial Co., Ltd.

### (Evaluation of Processability of Rubber Composition (Measurement of Mooney Viscosity))

In accordance with JIS K 6300 (L-shaped rotor), preheating was performed for 1 minute, and measurement was performed at a temperature of 100° C. for 4 minutes. An index was represented with the value of Comparative Example 3 as 100. As the value is smaller, the Mooney viscosity of the rubber composition is lower, which means excellent processability.

### (Evaluation of Post-Vulcanization Physical Properties of Vulcanized Rubber Containing Desulfurized Rubber (Measurement of Tension Product and Tensile Strength))

Each of the rubber compositions in Examples 5 to 8 and Comparative Examples 3 to 5 was vulcanized at 150° C. for 25 minutes to prepare a test piece having a predetermined shape, and the obtained test piece was subjected to the following test.
Tensile product: In accordance with JIS K6251, a tensile test (a dumbbell shape No. 3) was carried out to measure tensile strength and break elongation, and a product of these values was defined as a tension product. An index was represented with the value of Comparative Example 3 as 100. As the numerical value is larger, the post-vulcanization physical properties are excellent. The vulcanized rubber of the rubber composition containing the desulfurized rubber tends to have significantly deteriorated breaking elongation as compared with the vulcanized rubber of the rubber composition containing the non-desulfurized rubber. For this reason, the value of 95 or more is acceptable even if the value is less than 100 based on the value (100) of Comparative Example 3 which is a vulcanized rubber of a rubber composition containing a non-desulfurized rubber.
Tear strength: In accordance with JIS K 6252, a tear test (a crescent shape) was carried out to measure tear strength, and the tear strength was represented by an index with the value of Comparative Example 3 as 100. As the numerical value is larger, the post-vulcanization physical properties are excellent.

TABLE 3

| | Blending (parts by mass) | | | | | | |
|---|---|---|---|---|---|---|---|
| | Comparative | Comparative | Comparative | | | | |
| | Example 3 | Example 4 | Example 5 | Example 5 | Example 6 | Example 7 | Example 8 |
| Natural rubber | 100 | 100 | 100 | 100 | 100 | 100 | 100 |
| Carbon black | 50 | 50 | 50 | 50 | 50 | 50 | 50 |
| Zinc flower | 2 | 2 | 2 | 2 | 2 | 2 | 2 |
| Antiaging agent | 0.5 | 0.5 | 0.5 | 0.5 | 0.5 | 0.5 | 0.5 |
| Stearic acid | 2 | 2 | 2 | 2 | 2 | 2 | 2 |
| Sulfur | 2.5 | 2.5 | 2.5 | 2.5 | 2.5 | 2.5 | 2.5 |
| Vulcanization | 1 | 1 | 1 | 1 | 1 | 1 | 1 |
| accelerator | | | | | | | |
| Non-Desulfurized rubber | | 10 | | | | | |
| (Comparative Example 1) | | | | | | | |
| Desulfurized rubber | | | 10 | | | | |
| (Comparative Example 2) | | | | | | | |
| Desulfurized rubber | | | | 10 | | | |
| (Example 1) | | | | | | | |
| Desulfurized rubber | | | | | 10 | | |
| (Example 2) | | | | | | | |
| Desulfurized rubber | | | | | | 10 | |
| (Example 3) | | | | | | | |
| Desulfurized rubber | | | | | | | 10 |
| (Example 4) | | | | | | | |
| Mooney viscosity | 100 | 115 | 109 | 90 | 89 | 100 | 88 |
| Tension product | 100 | 95 | 99 | 99 | 99 | 98 | 99 |
| Tear strength | 100 | 85 | 75 | 127 | 123 | 100 | 118 |

From the results in Table 3, it is found that the rubber compositions according to Examples 5 to 8 have excellent processability, and the vulcanized rubbers have excellent post-vulcanization physical properties.

What is claimed is:

1. A desulfurized rubber obtained by mixing a desulfurization agent and a vulcanized rubber,
the desulfurization agent containing a compound represented by any one of the following formulae (1) to (4): 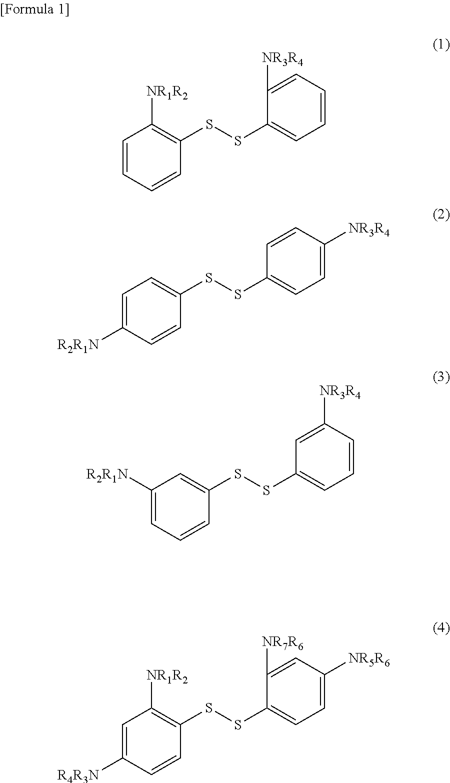
wherein R₁ to R₈ each independently represent a hydrogen atom, an oxygen atom, or an alkyl group.

2. The desulfurized rubber according to claim 1, wherein the desulfurization agent contains at least one selected from the group consisting of 2,2′-dithiodianiline and 4,4′-dithiodianiline.

3. A rubber composition comprising the desulfurized rubber according to claim 1.

4. A rubber composition comprising the desulfurized rubber according to claim 2.

5. The rubber composition according to claim 3, wherein the rubber composition contains 1 to 30 parts by mass of the desulfurized rubber based on 100 parts by mass of a total amount of an unvulcanized rubber component in the rubber composition.

6. The rubber composition according to claim 4, wherein the rubber composition contains 1 to 30 parts by mass of the desulfurized rubber based on 100 parts by mass of a total amount of an unvulcanized rubber component in the rubber composition.

7. A pneumatic tire comprising a rubber portion obtained by vulcanizing and molding the rubber composition according to claim 3.

8. A pneumatic tire comprising a rubber portion obtained by vulcanizing and molding the rubber composition according to claim 4.

9. A pneumatic tire comprising a rubber portion obtained by vulcanizing and molding the rubber composition according to claim 5

10. A pneumatic tire comprising a rubber portion obtained by vulcanizing and molding the rubber composition according to claim 6.
